(19) United States
(12) Patent Application Publication
(10) Pub. No.: US 2004/0021850 A1
(43) Pub. Date: Feb. 5, 2004

(54) Optical method and apparatus for inspecting documents

(76) Inventors: Peter Dilwyn Evans, Hampshire (GB); David Alan Brooks, Hampshire (GB); John Alan Skinner, Hampshire (GB); Simon George Calverley, Hampshire (GB)

Correspondence Address: Oliff & Berridge, PO Box 19928, Alexandria, VA, 22320, US

(21) Appl. No.: 10/415,669

(22) PCT Filed: Nov. 21, 2001
(86) PCT No.: PCT/GB01/05143

(30) Foreign Application Priority Data
Nov. 29, 2000 (GB) 0029157.5

(51) Int. Cl. G06K 9/74

(52) U.S. Cl. 356/71

(57) ABSTRACT

Document inspection apparatus comprises a document transport system (1) for transporting documents through a detector station (6). A linear array of separately activatable light sources (14, 15) at the detector (12) receives light transmitted through or reflected by any of the illuminated portions of the document and generates a corresponding output signal. A control system (9) sequentially activates the light sources and monitors the output signals from the detector.

The invention relates to methods and apparatus for obtaining information about documents, for example documents of value such as banknotes.

Document handling apparatus such as banknote counters, sorters and dispensers typically include a variety of detectors used to inspect banknotes as they are transported through the apparatus so as to determine certain characteristics of the banknotes such as authenticity and denomination. For example, it is common to inspect one or more of the reflection, fluorescent and transmission characteristics of documents when illuminated with light either in the visible or outside the visible range. The resultant, detected light is used to generate an image of the part of the document scanned and this is then compared with prestored images so as to determine denomination or other characteristics. However, these detection systems are expensive and complex requiring the use of a substantial number of illumination sources and detectors.

An example of apparatus for detecting the presence of an ink on a document is described in EP-A-0314312. In this case, an array of LEDs generate radiation beams of different wavelengths and these are modulated in respective different manners so that a single detector can be utilized, responsive to all the wavelengths, and from which information from each illuminating wavelength can be extracted. Typically, the modulations of the illuminating wavelengths will result in the banknote being illuminated by more than one wavelength at the same time in the same place.

In accordance with a first aspect of the present invention, a method of obtaining information about a document comprises transporting the document along a transport path; sequentially illuminating, with light having the same wavelength, a plurality of portions of the document along a line transverse to the transport direction; and detecting, using a common detector, light that has been transmitted through or reflected by the document so as to determine the response of the respective, different portions of the document to the illumination.

In accordance with a second aspect of the present invention, document inspection apparatus comprises a document transport system for transporting documents through a detector station; a linear array of separately activatable light sources at the detector station for illuminating corresponding portions of the document with light having the same wavelength; a common detector for receiving light transmitted through or reflected by any of the illuminated portions of the document and for generating a corresponding output signal; and a control system for sequentially activating the light sources and monitoring the output signals from the detector.

We have developed a simpler method and apparatus which utilizes a common detector for receiving illumination from a series of portions of the document. By illuminating the portions in sequence, it is not necessary to have a separate detector corresponding to each portion since it will be known which portion of the document is being illuminated at any particular time and the response of the detector can be correlated with the relevant portion.

Typically, the common detector will comprise a photodiode such as a strip photodiode. An example of such a photodiode is described in U.S. Pat. No. 5,309,515 in which a detector system is described determining the location of an edge of a document by monitoring light which has not been transmitted through the document.

The illumination wavelength would typically be outside the visible range, for example in the infra-red range but could also be within the visible range. Furthermore, in some cases it is useful to illuminate different portions with different colours or wavelengths so as to characterize different features of the document. Thus, some parts of the document may be illuminated in the visible range and others outside the visible range and so the method can be implemented separately in each part and a second implementation of the apparatus provided.

Typically, more than one set of portions will be illuminated as the document is transported so that an image of at least part of the document can be built up. For example an image of a signature (eg on a bank book) or a picture or security feature on the document. Alternatively, the image may simply be an outline of the document, for example to enable the location of the edges of the document to be determined.

The portions may extend to an edge of the document or across the central region of the document. Furthermore, additional arrays of portions could be illuminated, each array being associated with its own common detector and in some cases a number of sets could be organized so that the entire width of the document transverse to the transport direction is illuminated.

Typically, the light sources will comprise light emitting diodes although other types of light source, for example laser diodes could be used.

The or each detector will typically comprise a photodiode.

It is also possible to calibrate the intensity and/or detection threshold for each separate light source to allow for dirt build up and uneven device specification by scanning the light sources when no document is present.

It will be appreciated from the above discussion that the invention results in a relatively low cost detector which can take less time to scan than conventional detectors and has a smaller size. This is because for size detection the pixel resolution is less, therefore there are fewer LEDs to scan, so it takes less time to complete a scan. Absolute resolution is obtained in software by interpolation. As a result the pattern image provided has a lower resolution than existing arrangements.

As mentioned above, the invention can be used in many different types of document handling apparatus including security document counters, sorters, dispensers, recirculators, validators, and acceptors (all with both long and short edge feed). It has particular relevance to the handling of banknotes and other documents of value such as travellers cheques but could also be used in conjunction with other types of document including elongate webs.

Some examples of methods and apparatus according to the invention will now be described with reference to the accompanying drawings, in which:—

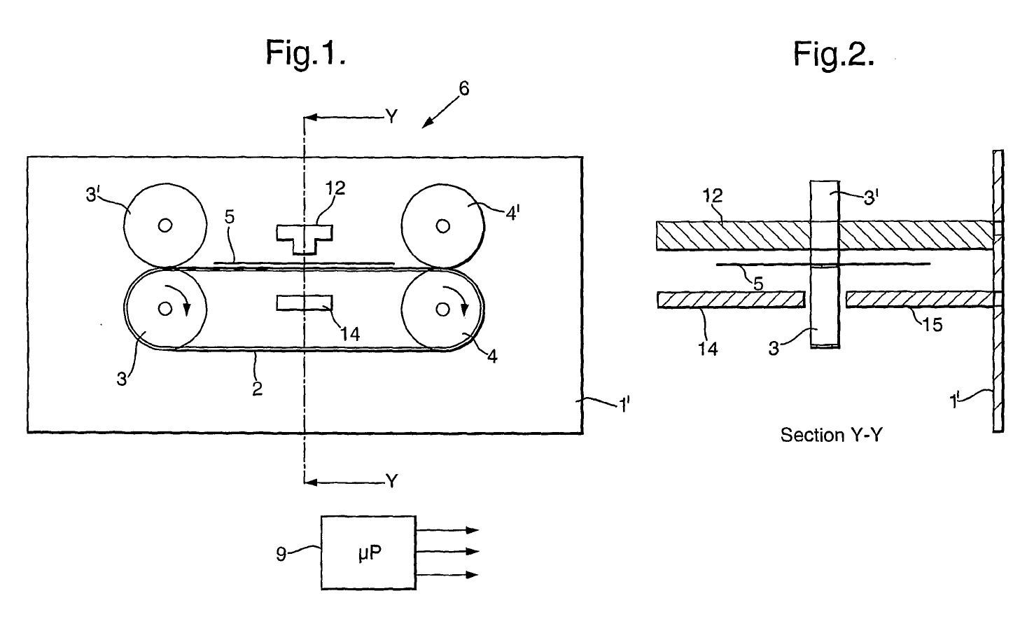

FIG. 1 is a schematic side view of part of one example of a document handling apparatus in which the detector is provided;

FIG. 2 is a section on the line Y-Y in FIG. 1;

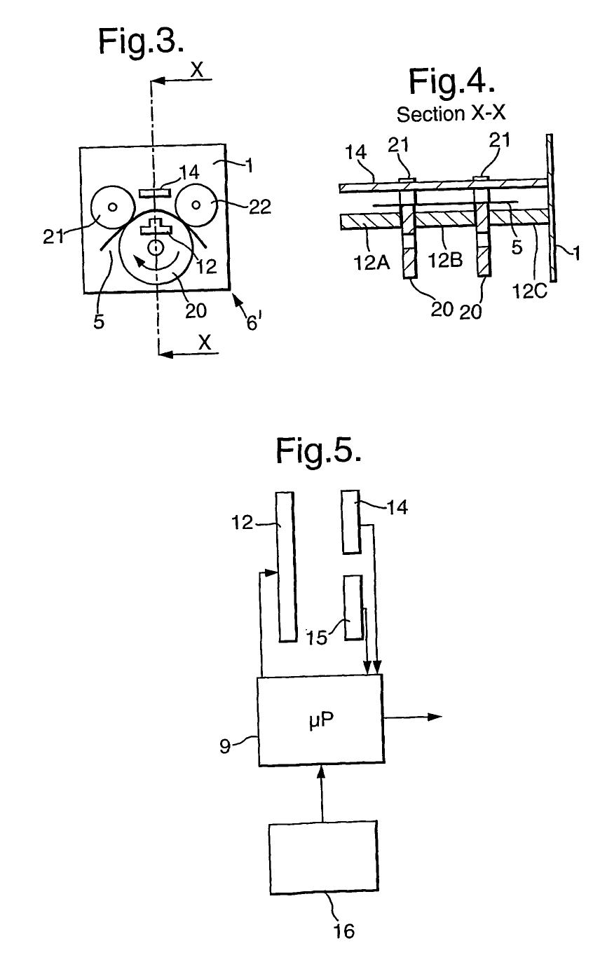

FIG. 3 is a side view of part of a second example;

FIG. 4 is a section on the line X-X in FIG. 3;

FIG. 5 is a block diagram of the primary processing components; and,

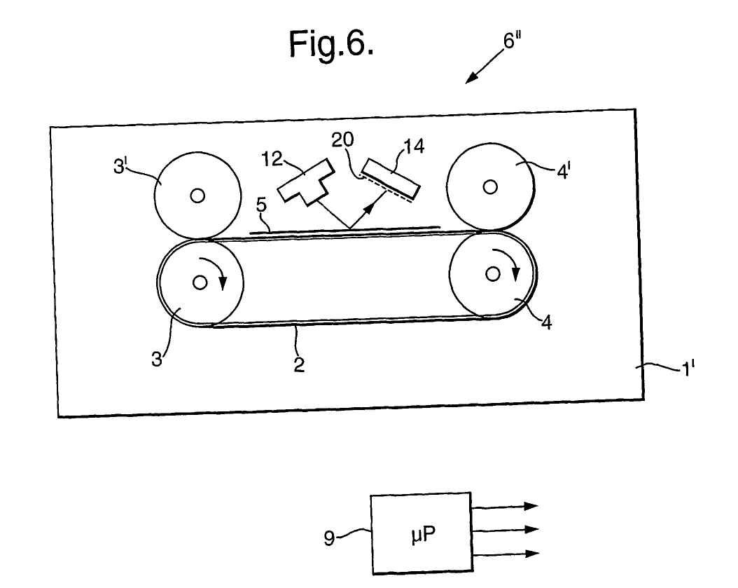

FIG. 6 is a view similar to FIG. 1 but of a third example.

The apparatus shown in FIG. 1 comprises a belt transport 1 mounted between side plates 1′ (only one shown) and comprising a friction feed belt 2 entrained around rollers 3,4. The rollers 3,4 rotate in the direction of the arrows under the control of a motor (not shown) and cooperate with pinch rollers 3′,4′ so that a banknote 5 supplied from a source (not shown) is carried by the belt 2 through a detecting station 6.

The components of the detection station 6 are shown in more detail in FIG. 2. Thus, the detector comprises a linear array of light emitting diodes (LEDs) 12. Each member of the array 12 is coupled with a driver which receives control signals from a microprocessor 9. As can be seen in FIG. 2, the LED array 12 is located above the position of a banknote 5 being transported through the detector station 6.

Positioned below and in alignment with the array 12 are a pair of strip photodiodes 14,15. Each strip photodiode 14,15 has a single sensing region extending along its full length and so cannot by itself provide lateral resolution.

A filter (not shown) may be located in front of the strip photodiodes 14,15 so as to limit the light reaching the photodiodes to that which is to be detected.

The control circuit is shown in FIG. 5 where it can be seen that the microprocessor 9 is coupled to the LED array 12 and to the strip photodiodes 14,15. The microprocessor 9 is also connected with a memory 16. The microprocessor 9 will generate suitable output signals for controlling downstream processing of the banknotes. The action of these control signals will vary depending upon the equipment in which the apparatus is located. This may involve stopping the transport, controlling a diverter to feed the banknote to a particular location or output pocket and the like.

The construction and control of the LEDs can be similar to that described in U.S. Pat. No. 5,309,515 which is incorporated herein by reference.

In use, banknotes 5 are conveyed through the detecting station 6 by the friction feed belt system 1. As the banknotes pass through the detecting station 6, the microprocessor 9 issues control signals to the LED driver so that the LEDs in the array 12 are illuminated in sequence. Typically, the LEDs will be illuminated in pairs, each LED of the pair corresponding to a different strip photodiode 14,15. Typically, they will be illuminated at a rate in the region 50-60 microseconds per LED (with a banknote feed speed being about 4 m/s. The LED current is controlled to provide an even illumination, the process being based on a previous calibration. The photodiode signal is further normalised by a process based on a more precise calibration. Each LED generates an infra-red beam with the same wavelength which passes to the corresponding strip photodiodes 14,15 either directly or through a portion of the banknote 5.

In this example, all the LEDs in the array 12 generate the same wavelength infrared beam. However, the array 12 could be broken down into two or more sub-arrays with all the LEDs in each sub-array generating the same wavelength but the wavelengths being different between the arrays.

The microprocessor 9 monitors the intensity of the signal received by the photodiodes 14,15 corresponding to each LED in the array 12 and stores the resultant intensity in respective locations in the memory 16. Lateral resolution is achieved because of the sequential illumination of the LEDs. That is, only two LEDs are on at any one time.

The LED array 12 is activated more than once so that a two-dimensional array of portions or pixels along each edge of the document are obtained (the note having been transported further between sampling intervals).

The microprocessor 9 then determines which pixels correspond to a portion of the document and which correspond to LEDs which did not overlie the document and ignores the latter “pixels” by discarding pixels whose intensity exceeds a threshold.

The remaining data which defines the intensity of infra-red light received through the document may then be further processed in a conventional manner and is then compared with one or more master pattern data sets stored in the memory 16. The comparison may be achieved using any conventional pattern comparison or recognition technique. In this way, the denomination and/or authenticity of the banknote 5 can be determined. In simple applications this may involve a comparison of one or more dimensions of the document with predetermined values. In more complex examples, a pattern or image on the document may be compared with predetermined patterns or images.

Having determined this aspect of the document, the microprocessor 9 then provides outputs to effect the operation of the document transport mechanism, the settings, for example mechanical positioning, thresholds etc. effecting the performance of other detectors or sensors within the document transport arrangement and/or communication means or indicating means (either internal to the document transport arrangement or externally of the document transport arrangement) based on the determined criteria.

FIGS. 3 and 4 illustrate an alternative structure for the detecting station 6 shown at 6′. The station 6′ has a pair of driven rollers 20 which form nips with respective rollers 21,22 at spaced positions around their circumference. A banknote 5 enters through the nips defined by the rollers 20 and 21 and is guided into the nips defined between the rollers 20,22. A set of three LED arrays 12A-12C are located opposite a single strip photodiode 14.

The control system for the FIG. 3 example will be similar to that shown in FIG. 5 except that the microprocessor 9 will be connected individually to each of the LED arrays 12A,12B,12C. In operation, one LED in each one of these three arrays (i.e. three LEDs) will be illuminated at a time. The LEDs are in illuminated in sequence as before.

In other examples (not shown) more than one strip photodiode may be associated with a single LED array. The important factor is that a strip photodiode is illuminated only by a single LED at any one time.

Further, these examples detect transmitted i.r. light. Other examples can instead detect reflected i.r. (or other wave lengths) light or indeed both transmitted and reflected by providing strip photodiodes on both sides of the document path. Thus, FIG. 6 illustrates an example in which reflected i.r. radiation is detected. The construction of the detecting station 6″ in this example is the same as FIG. 1 except that the strip photodiodes 14,15 are mounted on the same side of the transport as the LED array 12. In addition a filter 20 is located in front of the photodiodes 14,15.

1. A method of obtaining information about a document, the method comprising transporting the document along a transport path; sequentially illuminating, with light having the same wavelength, a plurality of portions of the document along a line transverse to the transport direction; and detecting, using a common detector, light that has been transmitted through or reflected by the document so as to determine the response of the respective, different portions of the document to the illumination.

2. A method according to claim 1, wherein the illumination wavelength is outside the visible range.

3. A method according to claim 2, wherein the illumination wavelength is in the infrared range.

4. A method according to any of the preceding claims, wherein one plurality of the portions is illuminated with a different wavelength from another plurality of portions.

5. A method according to any of the preceding claims, further comprising storing the response in a memory.

6. A method according to any of the preceding claims, further comprising repeating the illumination and detecting steps so as to determine the response of more than one array of portions.

7. A method according to any of the preceding claims, wherein the portions extend up to an edge of the document.

8. A method according to any of claims 1 to 6, wherein the portions extend across a central region of the document.

9. A method according to any of claims 1 to 6, wherein the portions extend across the full dimension of the document transverse to the transport direction.

10. A method according to any of the preceding claims, wherein the portions extend along a line substantially orthogonal to the transport direction.

11. A method of handling documents comprising obtaining information about each document using a method according to any of claims 1 to 10; comparing the obtained information with predetermined information; and processing the document thereafter in accordance with the result of the comparison.

12. A method of handling documents of value such as banknotes according to claim 11, wherein the comparison step determines one or both of the value and authenticity of the document.

13. Document inspection apparatus comprising a document transport system for transporting documents through a detector station; a linear array of separately activatable light sources at the detector station for illuminating corresponding portions of the document with light having the same wavelength; a common detector for receiving light transmitted through or reflected by any of the illuminated portions of the document and for generating a corresponding output signal; and a control system for sequentially activating the light sources and monitoring the output signals from the detector.

14. Apparatus according to claim 13, further comprising one or more further linear arrays of separately activatable light sources at the detector station for illuminating corresponding portions of a document, each array cooperating with a respective detector common to that array for receiving light transmitted through or reflected by any of the portions of the document illuminated by that array.

15. Apparatus according to claim 13 or claim 14, wherein the light sources comprise light emitting diodes.

16. Apparatus according to any of claims 13 to 15, wherein the or each detector comprises a photodiode.

17. Apparatus according to any of claims 13 to 16, wherein the light sources generate wavelengths outside the visible range.

18. Apparatus according to claim 17, wherein the light sources generate wavelengths in the infrared range.

19. Apparatus according to any of claims 13 to 18, wherein one plurality of the light sources generates illumination at a different wavelength from another plurality of light sources.

20. Document handling apparatus comprising document inspection apparatus according to any of claims 13 to 19; a store for storing predetermined data relating to the documents, wherein the control system is adapted to compare output signals from the or each detector with corresponding prestored data in the store and to issue appropriate control signals determining the further processing of the documents.

21. Apparatus according to claim 20, wherein the predetermined data relates to the value and/or authenticity of documents of value.
